(19) United States
(12) Patent Application Publication
(10) Pub. No.: US 2014/0374585 A1
(43) Pub. Date: Dec. 25, 2014

(54) ION GROUP IRRADIATION DEVICE, SECONDARY ION MASS SPECTROMETER, AND SECONDARY ION MASS SPECTROMETRY METHOD

(71) Applicant: CANON KABUSHIKI KAISHA, Tokyo (JP)

(72) Inventors: Yohei Murayama, Kawasaki-shi (JP); Masafumi Kyogaku, Yokohama-shi (JP); Kota Iwasaki, Atsugi-shi (JP); Naofumi Aoki, Nagoya-shi (JP)

(21) Appl. No.: 14/296,973

(22) Filed: Jun. 5, 2014

(30) Foreign Application Priority Data
Jun. 24, 2013 (JP) 2013-131783

(51) Int. Cl. H01J 49/14; H01J 49/00; H01J 49/44

(52) U.S. Cl. CPC H01J 49/14; H01J 49/446; H01J 49/0031
USPC 250/282; 250/492.3; 250/288; 250/287

(57) ABSTRACT

The present invention provides an ion group irradiation device for irradiating a sample with an ion group, comprising: an ion group selecting unit configured to select, from ions released from an ion source, at least two ion groups formed of ions having different average masses; and a primary ion irradiation unit configured to irradiate the sample with the at least two ion groups selected by the ion group selecting unit, wherein the ion group selecting unit selects at least one ion group and further selects the at least two ion groups from each of the selected at least one ion group.

### BACKGROUND OF THE INVENTION

1. Field of the Invention

The present invention relates to an ion group irradiation device. The present invention also relates to a secondary ion mass spectrometer and method for analyzing an atom and molecule forming a sample surface.

2. Description of the Related Art

Secondary ion mass spectrometry (SIMS) is an analysis method involving identifying an atom species or molecule species forming a sample surface by irradiating a sample with a primary ion beam and measuring a mass-to-charge ratio of secondary ions emitted from the sample surface. The SIMS has features of, for example, having high sensitivity, being able to comprehensively analyze multiple kinds of molecules, and being able to analyze a sample surface two-dimensionally with a high spatial resolution. Owing to those features, in recent years, a method involving identifying multiple kinds of molecules forming a biological tissue and visualizing a fine two-dimensional distribution state of the molecules through use of the SIMS has been drawing attention.

In the SIMS, secondary ions are emitted through a sputtering phenomenon caused by collision between primary ions and sample molecules. The secondary ions include a great number of ions such as those which are ionized without a molecular structure of sample molecules being decomposed (hereinafter referred to as “precursor ions”) and those which are ionized with a molecular structure being decomposed by sputtering (hereinafter referred to as “fragment ions”). Therefore, a secondary ion mass spectrum to be obtained includes a precursor ion peak and a fragment ion peak, and a sample molecular species may not be identified in some cases. In this case, when a sample is irradiated with two or more kinds of primary ions having different masses, and two or more kinds of secondary ion mass spectra thus obtained are compared to each other, the sample molecular species can be easily identified. On the other hand, a method of irradiating a sample with two or more kinds of primary ions takes long measurement time, and hence there is a problem in that sample molecules cannot be identified with satisfactory throughput.

Various procedures for shortening the measurement time have been devised. Japanese Patent No. 3358065 discloses a technology of collectively irradiating a sample with an ion group obtained by dividing one ion group into n sub-ion groups having fine time intervals as primary ions. A secondary ion mass spectrum reflecting the fine time intervals of the primary ions is obtained, and intensities of n peaks corresponding to a specified secondary ion species are accumulated. In general, according to the SIMS, in order to ensure a mass resolution of secondary ions, one ion group having a shorter time width is generated from one ion group, and in this case, the number of ions included in the ion group decreases, with the result that measurement takes time in order to obtain a sufficient secondary ion intensity. In Japanese Patent No. 3358065, a sample can be irradiated with primary ions without any loss of ions, and hence the measurement time can be shortened.

Meanwhile, a technology of identifying a sample molecular species with satisfactory throughput by enhancing detection sensitivity of precursor ions by irradiation with primary ions for suppressing decomposition of sample molecules has also been developed. Hitherto, it has been considered that metal cluster ions formed of a liquid metal such as gold or bismuth or polyatomic ions mainly containing fullerene are used as primary ions. Further, in recent years, gas cluster ions have been drawing attention. The gas cluster ions have a large cluster size, and hence kinetic energy per atom becomes small. Therefore, when the gas cluster ions are used as primary ions, decomposition of sample molecules is suppressed. Japanese Patent Application Laid-Open No. 2011-29043 discloses an apparatus for controlling the kinetic energy per atom of gas cluster ions to 20 eV or less.

The related-art SIMS apparatus has a problem in that it is difficult to distinguish precursor ions from fragment ions in a secondary ion mass spectrum to be obtained. When two or more kinds of secondary ion mass spectra are obtained by irradiation with two or more kinds of primary ions having different masses so as to solve the above-mentioned problem, there arises a problem in that measurement time becomes long.

According to the method disclosed in Japanese Patent No. 3358065, a spectrum in which n secondary ion mass spectra of the single kind are superimposed on each other is obtained instead of two or more kinds of secondary ion mass spectra. Therefore, measurement time can be shortened, but an ability to distinguish a precursor ion peak from a fragment ion peak is not improved.

When the apparatus disclosed in Japanese Patent Application Laid-Open No. 2011-29043 is used, fragment ions are relatively reduced in intensity, but are not completely eliminated. Therefore, there still remains a problem in that it is difficult to distinguish precursor ions from fragment ions.

### SUMMARY OF THE INVENTION

According to one embodiment of the present invention, there is provided an ion group irradiation device for irradiating a sample with an ion group, including: an ion source for generating ions; an ion group selecting unit configured to select, from the ions released from the ion source, two or more ion groups formed of ions having different average masses; and a primary ion irradiation unit configured to irradiate the sample with the two or more ion groups selected by the ion group selecting unit. The ion group selecting unit selects one or more ion groups and further selects the two or more ion groups from each of the selected one or more ion groups.

In the ion group irradiation device of the present invention, two or more kinds of secondary ion mass spectra can be obtained in short measurement time, and hence distinction of peaks between precursor ions and fragment ions and identification of a sample molecular species can be performed with satisfactory throughput.

Further features of the present invention will become apparent from the following description of exemplary embodiments with reference to the attached drawings.

### BRIEF DESCRIPTION OF THE DRAWINGS

FIGS. 1A and 1B are schematic diagrams illustrating the present invention.

FIGS. 2A and 2B are schematic diagrams illustrating an outline of an apparatus configuration according to a first embodiment of the present invention.

FIGS. 3A, 3B and 3C are schematic diagrams illustrating a secondary ion mass spectrum according to the first embodiment of the present invention.

FIG. 4 is a schematic diagram illustrating an outline of an apparatus configuration according to a second embodiment of the present invention.

FIGS. 5A, 5B and 5C are schematic diagrams illustrating an outline of an apparatus configuration according to a third embodiment of the present invention.

FIG. 6 is a schematic diagram illustrating a timing chart example according to a fourth embodiment of the present invention.

FIGS. 7A and 7B are schematic diagrams illustrating a timing chart example and a secondary ion mass spectrum according to a fifth embodiment of the present invention.

### DESCRIPTION OF THE EMBODIMENTS

Preferred embodiments of the present invention will now be described in detail in accordance with the accompanying drawings.

The application of an ion irradiation device of the present invention is not particularly limited and may be used as a part of a secondary ion mass spectrometer or as a surface treatment device or a surface modifying device. In the following description, embodiments in which the ion irradiation device of the present invention is used as a part of the secondary ion mass spectrometer are described in detail. Note that, the following descriptions of each embodiment and illustrations of the drawings are merely exemplifications of the present invention, and the present invention is not limited to those descriptions and illustrations even in the case where nothing is particularly referred to. Further, the case of carrying out the present invention by combining multiple examples within a range not causing any contradiction also falls in the scope of the present invention.

### First Embodiment

There is provided an ion group irradiation device for irradiating a sample with an ion group, including: an ion source for generating ions; an ion group selecting unit configured to select, from the ions released from the ion source, two or more ion groups formed of ions having different average masses; and a primary ion irradiation unit configured to irradiate the sample with the two or more ion groups selected by the ion group selecting unit. The ion group selecting unit selects one or more ion groups and further selects the two or more ion groups from each of the selected one or more ion groups.

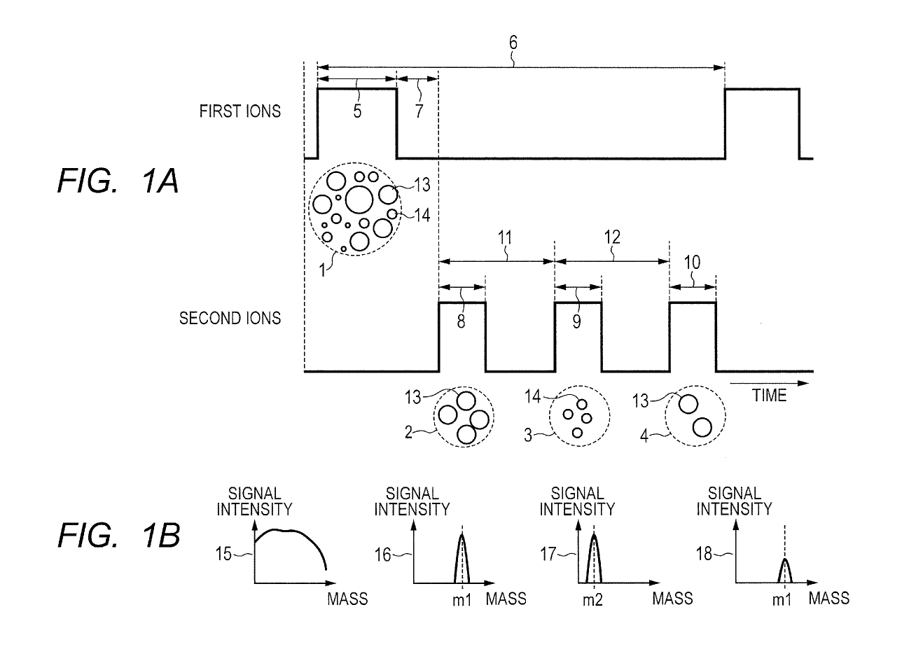

A first embodiment of the present invention is described with reference to FIGS. 1A and 1B. Note that, the drawings illustrate merely an example for describing the present invention, and the present invention is not limited thereto.

An ion group selecting unit of the present invention selects an ion group from ions released from an ion source and further selects two or more ion groups from the one selected ion group. In the specification of the present application, description is made defining an ion group selected from ions released from the ion source to be a first ion group and defining two or more ion groups selected from the one first ion group to be second ion groups. In FIG. 1A, an ion group 1 corresponds to a first ion group, and ion groups 2, 3, and 4 correspond to second ion groups.

An ion group irradiation unit irradiates a sample with the second ion groups 2, 3, and 4 including two or more selected ion groups. In the specification of the present application, the second ion groups with which the sample is to be irradiated are sometimes referred to as primary ions. The ion source refers to a unit configured to generate and release ions from an ion material, that is, a unit configured to generate ions. As illustrated in FIG. 1A, the first ion group refers to an aggregate of ions selected in a specified time width 5 by the ion group selecting unit. The first ion group may be repeatedly selected during a time interval 6. The second ion groups refer to aggregates of ions selected by the ion group selecting unit in time widths 8, 9, and 10 from the first ion group at least after a time difference 7 from time when the first ion group has been selected. The second ion groups illustrated in FIG. 1A are selected respectively at different times but may be selected simultaneously. The second ion groups being selected respectively at different times refers to that the second ion groups are selected with time differences (11, 12).

The first and second ion groups are respectively formed of two or more ions. The two or more ions respectively have a specified mass. The kind of an ion is determined based on an atom or an atom group, a mass, and a valence of an ion. When the atom or the atom group of an ion varies, the mass of the ion varies. Further, the kind of an ion group is determined based on the kind of ions forming the ion group. Thus, when the kind of ions forming an ion group varies, at least the kind of the ion group varies, and at least the average mass of ions forming the ion group varies.

The first ion group 1 is obtained by selecting a part of ions released from the ion source, in which various kinds of ions are mixed. In the example of FIG. 1A, the first ion group 1 includes at least ions 13 and 14 having different masses.

The second ion groups 2, 3, and 4 are obtained by selecting specified ions as target ions from the first ion group in which various kinds of ions are mixed. In the example of FIG. 1A, the second ion groups 2, 3, and 4 respectively include the ions 13, 14, and 13 as target ions.

Note that, an ion group being formed of one kind of ions refers to that two or more ions are identical in terms of an atom, an atom group, a mass, and a valence. Note that, in the case where ions are cluster ions (described later), when the ions are selected as an ion group, a mass distribution has a width to some degree; therefore, one group present in a predetermined mass distribution may be defined as one kind of ions.

In the case where the mass distribution of cluster ions in the above-mentioned one group follows a normal distribution N (μ, σ²) (where μ: mean, σ²: variance), one kind of cluster ions includes ions shifted from μ by preferably ±3σ, more preferably ±σ. Also in the case where the molecular weight of the cluster ions follows a distribution other than the normal distribution, the cluster ions are defined accordingly.

Even in the case where the mass distribution of the cluster ions in the above-mentioned one group does not have a complete symmetric form, if there is one peak and a half-value width is sufficiently small, those ions can be defined as one kind of cluster ions.

Further, an ion group being formed of one kind of ions includes the case where an ion group includes a trace amount of ions other than the one kind of ions to such a degree as not to interfere analysis.

For example, the ion group 2 is formed of the ions 13, but may include a trace amount of the ions 14 or the other ions to such a degree as not to interfere analysis of the mass spectrometer of the present invention. When the proportion of ions mixed with one kind of ions is high, the time width of an ion group is likely to be enlarged before the ion group reaches a sample, and the time width of secondary ions obtained from the sample becomes large, with the result that mass resolution is degraded. The degree to which measurement is not interfered refers to a degree to which the above-mentioned problem is not caused, and the proportion is preferably 10% or less, more preferably 1% or less.

The average mass of an ion group is determined by various conditions such as the kind and supply pressure of an ion material to be used, the configurations of various components in an ion group irradiation device, and selection conditions such as the applied voltage and time for selecting the first and second ion groups. For example, in the case of selecting the first ion group under the same selection conditions in the same ion material and supply pressure and the same ion group irradiation device, an ion group formed of ions having different average masses can be selected by changing selection conditions of the second ion group.

As the average mass in the present invention, an average mass in a mass spectrum of an ion group may be used or a mass obtained by calculating an average mass through use of various conditions such as the kind of the ion group, the configuration of the ion group irradiation device, and the selection conditions of the first and second ion groups. The mass spectrum of an ion group can be obtained by mass spectrometry of an ion group, and may be measured in the apparatus of the present invention or may be measured in another apparatus in advance. In the case of measuring a mass spectrum in the apparatus of the present invention, for example, a micro-channel plate (MCP) is set in the vicinity of a sample, and the sample is irradiated with the second ion group selected by changing the selection conditions of the second ion group. Regarding two or more second ion groups, an average mass of ions forming each ion group is obtained from two or more peaks of a mass spectrum measured by the MCP.

Note that, even in the case of one kind of ions, two or more ions actually generated from the ion source have existing positions and kinetic energies varying for each ion in a space in the vicinity of the ion source. Therefore, the conditions such as time and an applied voltage required for selecting two or more ions of one kind as one ion group and detecting the one ion group with a detector vary for each ion. Due to this variation, a mass spectrum obtained by actual measurement has a continuous spectrum having a width even in an ion group formed of ions having the same mass. In addition, the half-value width of a mass spectrum becomes larger as the number of kinds of ions included in an ion group is larger. FIG. 1B illustrates a conceptual diagram of a mass spectrum. The first ion group 1 includes ions having various masses, and hence a mass spectrum 15 having a wide half-value width is to be actually measured therefrom. On the other hand, the second ion groups 2, 3, and 4 include ions having more limited masses, and hence the half-value width of mass spectra 16, 17, and 18 thereof becomes smaller than at least the mass spectrum 15 of the first ion group. In the case where a mass spectrum has a symmetric form with respect to a mass m1, m2, or m1 at a peak position as in the mass spectra 16, 17, and 18, the mass m1, m2, or m1 serves as an average mass. In the case where a mass spectrum does not have a completely symmetric form, if there is one peak and the half-value width is sufficiently small, a mass at a peak position may be used as an average mass. Alternatively, a peak position is obtained by peak fitting based on a Gauss function or the like, and the mass at that position may be used as an average mass. Note that, when the half-value width of a mass spectrum is large, the mass resolution of a secondary ion mass spectrum is degraded, and a difference is unlikely to be caused in secondary ion mass spectra to be obtained even when a sample is irradiated with ion groups having different average masses. Therefore, it is preferred that that the half-value width of the mass spectrum be small. Two or more ion groups may be regarded as ion groups formed of ions having different average masses even when peak shapes partially overlap each other, as long as average masses are different from each other when peaks of actually measured mass spectra are compared to each other. Note that, even when peaks of two or more ion groups obtained under the same ion group selection condition in the same ion material and supply pressure and the same ion group irradiation device have slightly different average masses and peak shapes, those differences are considered as an error, and those ions are not regarded as having different average masses.

In the present invention, two or more second ion groups include two or more ion groups having different average masses. When the kind of ions forming an ion group varies, the average mass of the ions forming the ion group varies. As illustrated in FIG. 1B, the average masses of ions forming the second ion groups 2, 3, and 4 are respectively m1, m2, and m1. As illustrated in FIG. 1B, the mass m1 of the ions forming the second ion group 2 is different from that of the ion group 3 but is equal to that of the ion group 4. That is, as illustrated in FIG. 1B, two or more second ion groups of the present invention include at least one combination of the second ion groups 2 and 3 or the second ion groups 3 and 4. In the present invention, as long as the second ion groups include two or more ion groups having different ion average masses, the second ion groups may include two or more ion groups having the same ion average mass.

Further, in the present invention, the time interval 6 between first ion groups to be selected is not particularly limited as long as the time interval 6 is larger than any one of the time difference 7 from the second ion group, the sum of the time differences 7 and 11, and the sum of the time differences 7 and 12, but preferably 10 μsec to 100 msec. Further, the time width 5 of the first ion group is not particularly limited, but is preferably 0.1 nsec to 50 μsec. Further, all of the time difference 7 between the first ion group and two or more second ion groups, the sum of the time differences 7 and 11, and the sum of the time differences 7 and 12 are not particularly limited, but preferably 0.1 μsec to 10 msec. Further, the time widths 8, 9, and 10 of the second ion groups are not particularly limited, but preferably 0.1 nsec to 50 μsec.

A sample is irradiated with the second ion groups selected as described with a time difference by the ion group irradiation unit. Note that, in the case where samples to be irradiated with the second ion groups are not the same or different regions of the same sample are irradiated with the second ion groups, the irradiation may be performed simultaneously. This time difference may be the same as or different from a time difference (11, 12 in FIG. 1A) with which the second ion groups are to be selected. In the case where the above-mentioned time difference is different from the time difference with which the second ion groups are to be selected, the order of irradiation may be the same as or different from the order of selection.

The same surface region of the same sample may be irradiated with two or more ion groups of the present invention, multiple surface regions of the same sample may be irradiated with the two or more ion groups of the present invention, or the irradiation of the two or more ion groups may be varied for each sample and region.

When the same surface region of the same sample is irradiated with the two or more ion groups of the present invention, a molecule species can be identified in an irradiation region with satisfactory throughput by secondary ion mass spectrometry. In addition, in the case where secondary ion mass spectrometry in a depth direction is intended, analysis can be performed while a sputtering rate with respect to a surface is being changed easily at a high speed. Further, in the case where surface treatment or surface modification is intended, the surface treatment or the surface modification can be performed with satisfactory throughput while an etching rate, surface roughness, and a coating film thickness are being changed easily.

When multiple different surface regions of the same sample are irradiated, an ion group suitable for target molecules can be selected for each region, and secondary ion mass spectrometry can be performed with satisfactory throughput. In addition, previous study for selecting an ion group suitable for a sample and target molecules can be performed with satisfactory throughput. Further, in the case where surface treatment or surface modification is intended, a surface having an etching depth, surface roughness, and a coating film thickness varying for each of multiple surface regions can be obtained with satisfactory throughput.

The ions in the present invention refer to charged atoms or atom group and include all ions. As preferred examples of the ions, there may be given various cluster ions. The cluster refers to an object in which two or more atoms or molecules are bound by an interaction such as a Van der Waals' force, an electrostatic interaction, a hydrogen bond, a metallic bond, or a covalent bond, and the cluster ion refers to a charged cluster. Further, the cluster ion may be formed of one kind of atom or molecule, or two or more kinds of atoms or molecules. Note that, an ion formed of one atom or molecule is called a monomer ion, which is discriminated from the cluster ion. For example, an ion formed of one water molecule is not a cluster ion but a monomer ion. Note that, only in the case of a fullerene molecule formed of 60 carbon atoms, one fullerene molecule may be exceptionally regarded as a cluster ion.

In the case where the ion is a cluster ion, as a preferred example of the first ion group in the present invention, there may be given the following. Specifically, the first ion group is formed of two or more cluster ions of two or more kinds, and the two or more cluster ions of two or more kinds refer to those which are selected from the same ion source, that is, those in which atoms or molecules forming each unit of respective clusters are the same and only the number of units forming the cluster is different (for example, cluster ions formed of X gold atoms and cluster ions formed of Y gold atoms).

Preferred examples of the cluster ions in the present invention include cluster ions formed of gold, bismuth, xenon, argon, and water, and ions of fullerene which is a cluster formed of carbon.

Examples of the cluster ions of gold include cluster ions in which 2 to 1,000 gold atoms are bound through a metallic bond and ionized. Examples of the cluster ions of bismuth include cluster ions in which 2 to 1,000 bismuth atoms are bound through a metallic bond and ionized. Examples of the cluster ions of argon include cluster ions in which 2 to 100,000 argon atoms are aggregated by the Van der Waals' force and ionized. Examples of the cluster ions of water include cluster ions in which 2 to 100,000 water molecules are bound through a hydrogen bond and ionized. Examples of the cluster ions of carbon include fullerene in which 60 carbon atoms are bound through a covalent bond and fullerene ions in which 2 to 1,000 fullerenes are further aggregated by the Van der Waals' force and ionized.

Further, as preferred examples of ions other than the cluster ions in the present invention, there may be given monomer ions. Specific examples thereof include monatomic ions each formed of one atom such as gold, bismuth, argon, and xenon; and monomolecular ions each formed of one molecule such as water.

Note that, in the specification of the present application, in the case where the ions are cluster ions, one cluster ion is considered as one ion irrespective of the form of a bond in a cluster, and the mass of ions refers to a mass obtained by subtracting a mass of lost electrons from the total mass of atoms forming the ion or a mass obtained by adding a mass of added electrons to the total mass of the atoms forming the ion. Further, in the specification, the term “particle” may be used as a concept including an atom, a molecule, and a cluster. Further, that cluster ions have the same ion species refers to that elements forming a cluster, and the number, bond form, and valence of the elements are the same.

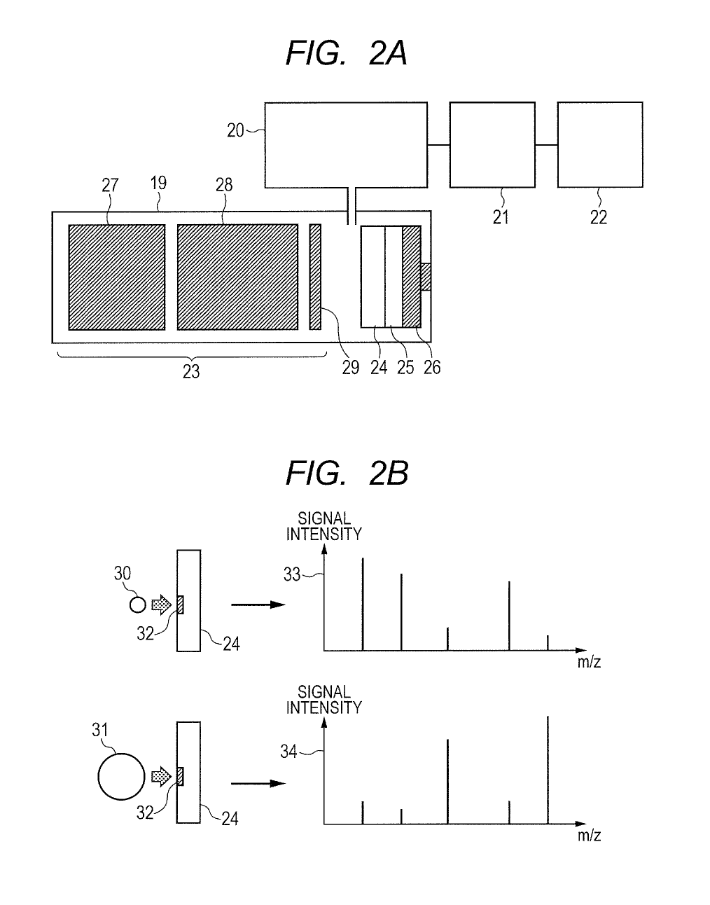

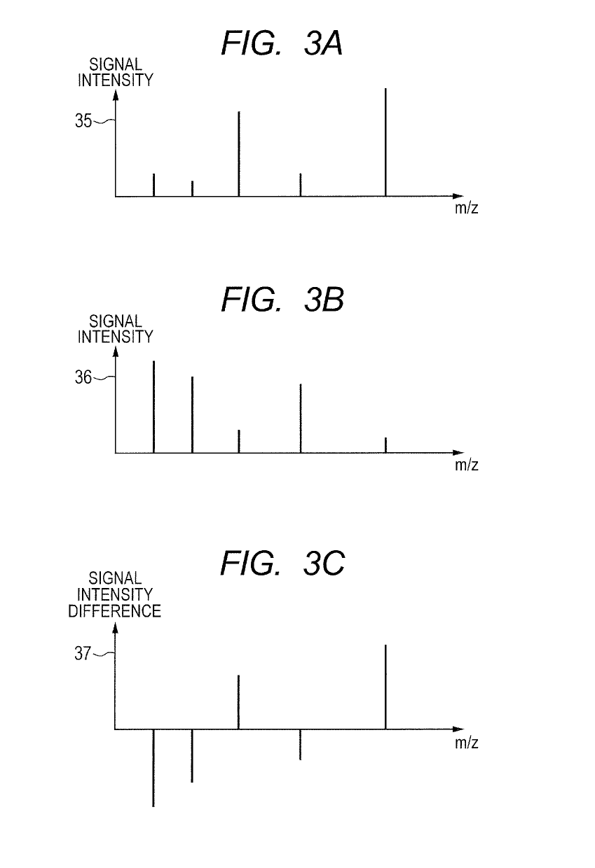

This embodiment is further described with reference to FIGS. 2A, 2B, and 3A to 3C.

FIG. 2A is a schematic view illustrating an apparatus of the present invention. The apparatus of the present invention includes a primary ion irradiation device 19 for emitting primary ions and a mass spectrometer 20 for subjecting the generated secondary ions to mass spectrometry. The apparatus further includes an analysis device 21 for analyzing a mass spectrum and a mass distribution image of obtained secondary ions and an output device 22 for outputting the mass spectrum and the mass distribution image.

FIG. 2B is a schematic view in which a sample 24 is irradiated with secondary ion groups 30 and 31. The average masses of ions forming the secondary ion groups 30 and 31 are respectively M1 and M2, which are different from each other. The sample 24 is fixed onto a substrate 25 and held by a sample holding unit 26. FIG. 2B illustrates the case where the same sample 24 is used. However, the sample in the present invention may be the same or different for each ion group with which the sample is irradiated. Note that, it is preferred that the same sample be used from the viewpoint of analysis accuracy. In the case where different samples are used, it is preferred that the samples have surfaces which can be considered to be substantially the same even between different samples, for example, as in adjacent segments of a biological tissue. Further, FIG. 2B illustrates the case where the same region 32 of the same sample 24 is irradiated with ion groups. However, in the present invention, regions to be irradiated with ion groups may be the same or different. Note that, it is more preferred that the regions to be irradiated with ion groups be the same from the viewpoint of analysis accuracy. Further, in the case where the regions are different from each other, it is preferred that those regions include at least the same position.

Secondary ions generated through irradiation are analyzed by the mass spectrometer 20 and analyzed by the analysis device 21, and secondary ion mass spectra 33 and 34 different from each other are obtained from the output device 22. The obtained secondary ion mass spectra 33 and may be subjected to difference analysis between the spectra and output. Further, a mass distribution image may be analyzed and output. One or two or more mass spectrometers 20 may be used. It is preferred that one mass spectrometer 20 be used from the viewpoint of an apparatus size and an operation cost.

The primary ion irradiation device 19 of FIG. 2A includes a primary ion irradiation unit 23, the sample 24, the substrate 25, and the sample holding unit 26. The primary ion irradiation device 19 may separately include a mass measurement unit configured to obtain a mass spectrum of an ion group. The primary ion irradiation unit 23 includes an ion source 27, an ion group selecting unit 28, and an ion group irradiation unit 29. A first ion group is selected from ions released from the ion source 27 by the ion group selecting unit 28, and further two or more second ion groups are selected from one first ion group. The selected ion groups are accelerated to several to several KeV by a potential difference from the ion group selecting unit 28 or the ion group irradiation unit 29 to a sample surface, and a specified region on the sample surface is irradiated with the ion groups. Note that, the ion group irradiation unit 29 may be a part of the ion group selecting unit 28, and in this case, the ion group irradiation unit 29 may not be provided separately. Further, the ion group irradiation unit 29 may include a converging electrode for converging an irradiation diameter of an ion group, a re-acceleration electrode for re-accelerating ions, and a deflection electrode for deflecting ions. One or two or more primary ion irradiation units may be used. It is preferred that one primary ion irradiation unit be used from the viewpoint of an apparatus size and an operation cost. Further, one or two or more ion sources 27, ion group selecting units 28, and ion group irradiation units 29 may be included in one primary ion irradiation unit.

The ion source 27 includes at least an ion material and an ion material supply unit. Further, in the case where the ion material is uncharged neutral particles, that is, neutral atoms or molecules, a neutral cluster, or the like, the ion source 27 includes an ionization unit. Further, as needed, a skimmer for removing excessively large neutral particles or a buffer container for differential evacuation may be provided between the ion material supply unit and the ionization unit.

The ion material refers to a substance to be a material for ions serving as primary ions with which a sample is irradiated. The kind and state of the ion material are not particularly limited, and the ion material is an aggregate of neutral or charged particles. The particles may be formed of one kind of atom or molecule, or may be formed of a mixture of multiple kinds of atoms or molecules. The ion material may be in a state of a gas, a liquid, or a solid at normal temperature and normal pressure. The ion material may also be in a mixed state of a gas and a liquid or in a state in which a solid is dissolved in a gas or a liquid. Preferred examples of the gas include: rare gases such as argon and xenon; and oxygen. Preferred examples of the liquid include water, an acid, an alcohol, and an alkali. Preferred examples of the solid include metals such as gold and bismuth, and fullerene.

An ion species included in an ion group with which a sample is irradiated may be appropriately selected depending on the kind of sample molecules to be detected. For example, the detection sensitivity can be enhanced in some cases by adding an ion to a target molecule intentionally. Examples of the ion to be added include a hydrogen ion, a sodium ion, a potassium ion, an ammonia ion, a silver ion, a gold ion, and a chlorine ion.

An ion species included in an ion group with which a sample is irradiated can be selected by selecting an ion material to be used or by the ion group selecting unit. For example, in the case where it is intended to add a hydrogen ion, an ion species containing a great amount of hydrogen can be easily generated by incorporating any one of water, an acid, and an alcohol into an ion material. In addition, in the case where it is intended to add a sodium ion, a potassium ion, an ammonia ion, a silver ion, a gold ion, or a chlorine ion, an organic salt or inorganic salt containing sodium, potassium, silver, gold, or chlorine may be incorporated into the ion material. A typical substance of the sodium salt is, for example, sodium formate, sodium acetate, sodium trifluoroacetate, sodium hydrogen carbonate, sodium chloride, or sodium iodide. Even when the organic salt or inorganic salt itself is a solid, the salt may be easily used as the ion material by being added to a liquid such as water.

The structure of the ion material supply unit is not limited, and for example, the ion material supply unit can include a container for holding an ion material, a nozzle or an emitter for supplying an ion material, and a heating and pressurizing mechanism. The ion material supply unit may supply an ion material intermittently or continuously. It is preferred that an ion material be supplied intermittently, for example, through use of an intermittent valve from the viewpoint of maintaining a vacuum state of the device. The ion material supply unit may have a function of generating ions so as to be grouped for each mass. For example, the ion material supply unit may include a temperature regulator for separating ions based on a difference in boiling point or melting point, and an aerodynamic particle diameter distribution measurement device for separating ions based on a difference in particle diameter.

An ionization method is not particularly limited, and examples thereof include electron impact ionization, chemical ionization, photoionization, surface ionization, a field-emission method, plasma ionization, penning ionization, and an electrospray ionization. For example, in ionization of a gas such as a rare gas such as argon or xenon, or oxygen, monatomic ions and cluster ions are obtained by performing electron impact ionization with respect to neutral cluster particles generated by jetting the rare gas to the vacuum through a nozzle. Further, in ionization of a liquid such as water, an acid, an alcohol, or an alkali, monomolecular ions and cluster ions are obtained by heating the liquid with the ion material supply unit to obtain a gas and performing electron impact ionization with respect to the gas in the same way as in the rare gas or the like. Further, in the other methods, water, an acid, or an alcohol is allowed to flow as a liquid through a nozzle in a vacuum, and a high voltage of about several kV is applied to a tip end of the nozzle, whereby the liquid can be ionized by an electrospray method. Further, in ionization of a metal such as gold or bismuth, monatomic ions and cluster ions are obtained by a field-emission method by heating a metal applied to a tungsten emitter in a vacuum and applying an electrostatic field between an extraction electrode and a tip end of the emitter. In ionization of fullerene, monomolecular ions and cluster ions are obtained by heating fullerene with the ion material supply unit to obtain a gas and performing electron impact ionization with respect to the gas in the same way as in the rare gas or the like. Note that, ionization may be performed continuously or intermittently in the ionization method.

The ion group selecting unit includes a first ion group selecting unit configured to select a first ion group from ions generated from an ion source, and a second ion group selecting unit configured to select two or more second ion groups from one first ion group. The first and second ion group selecting units may have a part in common or may be independent from each other. An ion group with which a sample is irradiated can be generated with more satisfactory efficiency by selecting two or more second ion groups from one first ion group than selecting one second ion group from one first ion group. Therefore, measurement time can be shortened even in the case where a sample is irradiated with two or more ion groups having different average masses of ions forming the ion groups.

As the ion group selecting unit, various ion separators and choppers, or a combination thereof can be used. The ion separator refers to a unit configured to separate an aggregate formed of multiple kinds of ions in a gaseous phase based on properties (mass, charge number, three-dimensional shape, etc.) of ions. The ion separator is not particularly limited, and a time-of-flight mass separator, a quadrupole mass separator, an ion-trap mass separator, a magnetic mass separator, an ExB filter, an ion mobility separator, or the like is preferably used. The chopper is a unit configured to intermittently pass ions by repeating opening and closing. The ions are divided in the traveling direction with the chopper, and one or more ion groups are selected. The chopping operation refers to an operation of selecting one or more ion groups by passing and blocking ions in the traveling direction by opening and closing of the chopper. The chopper blocks ions in the traveling direction in a closed state and passes ions in the traveling direction in an opened state. The operation in which the chopper changes from a closed state to a closed state again after undergoing an opened state for a predetermined period of time is counted as one chopping operation. The configuration of the chopper is not particularly limited, and a combination of a deflection electrode and an aperture, a mesh-shaped retarding electrode, a circular flat plate with an aperture which rotates at a high speed, or the like is preferably used. In the present invention, a combination of a deflection electrode and an aperture can be more preferably used from the viewpoint of operation timing controllability and ion convergence.

The drive method for an opening and closing operation of the chopper is not particularly limited, and a suitable drive method may be selected depending on the kind of the chopper. In the case where the chopper is a combination of a deflection electrode and an aperture, the opening and closing operation of the chopper can be performed with satisfactory accuracy by supplying a voltage to the deflection electrode through use of a waveform generator. Further, a voltage application signal to the deflection electrode can be branched and sent to a mass spectrometer as a trigger signal at the same time or at time delayed by predetermined time through a delay time generation device. In this case, the chopping operation by the chopper and secondary ion measurement by the mass spectrometer can be coordinated with satisfactory accuracy.

When the sample is irradiated with the second ion group, the sample may be irradiated with and scanned by a converged secondary ion group (scanning type), or a specified region of the sample may be irradiated with a secondary ion group collectively (projection type).

In the case of the scanning type, the ion group for irradiation is converged through use of a converging electrode and further deflected through use of a deflection electrode, an thus a minute region on the sample is irradiated with and scanned by the ion group. The irradiation diameter is not limited, but is preferably about 0.01 μmφ to 50 μmφ considering that the irradiation diameter directly influences the spatial resolution of a mass image obtained by secondary ion mass spectrometry.

In the case of the projection type, the irradiation diameter for irradiation of the ion group is converged or enlarged through use of a converging electrode, and the ion group is deflected through use of a deflection electrode, as needed, and thus a specified region of the sample is irradiated with the ion group collectively. The irradiation diameter in the projection type is not particularly limited, but is preferably about 0.01 mmφ to 10 mmφ because this diameter corresponds to the area of a measurement region.

In the present invention, the sample is irradiated with two or more second ion groups. As illustrated in FIG. 2B, when the average mass of ions forming the ion group with which the sample is irradiated varies, the intensity of each peak of a secondary ion spectrum to be obtained varies. By integrating those different spectra, a mass spectrum only formed of ions to be analyzed (e.g., precursor ions) can be obtained.

As the mass of ions serving as primary ions forming the second ion group becomes larger, fragmentation of sample molecules is suppressed more, and hence precursor ions tend to be obtained as secondary ions. On the other hand, when the mass is too large, a secondary ion spectrum may not be obtained easily in some cases. The mass of ions serving as primary ions for forming the second ion group can be selected appropriately in accordance with the molecular weight of molecules forming a target region, in particular, precursor ions (or fragment ions) to be focused.

The difference in mass of constituent ions between the second ion groups, is not particularly limited. However, when the mass difference of primary ions is too small, the difference of secondary ion spectra to be obtained is not likely to be obtained in some cases. Therefore, the difference in mass of constituent ions between the ion groups is preferably 100 or more, more preferably 500 or more, still more preferably 2,000 or more.

The sample 24 is a solid or a liquid, and includes an organic compound, an inorganic compound, or a biological sample or the like. An example of fixing the sample is fixing the sample to the flat substrate 25 and holding the sample on the sample holding unit 26.

The material for the substrate 25 is not limited, and a metal such as gold, ITO, or silicon or glass whose surface is coated with the metal or ITO is preferably used from the viewpoint of suppressing charging of the sample 24 involved in primary ion irradiation and secondary ion release.

The sample holding unit 26 includes a region for holding the sample 24 and the substrate 25, and further may include a Faraday cup for measuring a current value of the ion group with which the sample 24 is irradiated. Further, the sample holding unit 26 may include a temperature adjustment mechanism for heating or cooling the sample.

It is preferred that the sample holding unit 26 be moved or rotated in a horizontal direction or moved in a height direction. A region and height for irradiation of primary ions can be adjusted through the control in an in-plane direction and a height direction. Further, it is preferred that the sample holding unit 26 can also be inclined. An incident angle of primary ions with respect to a sample surface can be controlled through the control of inclination. Although primary ions may enter the sample surface coaxially or at different incident angles for each ion group, it is preferred that the ions enter the sample surface coaxially.

How many times the sample is irradiated with the second ion group (number of ion groups for irradiation) is not particularly limited. In the case where the same region of the same sample is irradiated with the second ion group multiple times, the operation can also be finished before the ion amount to be irradiated reaches a static limit or more. The static limit refers to a level at which the phenomenon that ions strike a position once and other ions strike the same position again is negligible according to theory of probability. The ion irradiation amount in this case is 1% or less of atoms and molecules forming the surface.

The number of irradiations of each second ion group and the order thereof are not particularly limited. The number or order of irradiations of the second ion groups for each kind may be on a random basis or on a regular basis. As an example, the following pattern is considered: (a) the number and order of irradiations are random for each kind of ion groups; (b) the kind of the ion group is the same at a specified number of time and the other is random; (c) the number and order of irradiations have a specified rule for each sequence, which is repeated; and (d) multiple sequences are repeated randomly or regularly.

Secondary ions generated from a sample surface which is irradiated with ion groups are measured by a mass spectrometer. The mass spectrometer includes an extraction electrode for extracting secondary ions in the vicinity of the sample, a mass separation portion for separating the secondary ions extracted by the extraction electrode based on a mass-to-charge ratio, and a detector for detecting each separated secondary ion.

Further, the mass spectrometer may include, besides the mass separation portion, a secondary ion group selecting mechanism for selecting only a part of the generated secondary ions as the secondary ion group. The time width of secondary ions can be shortened by selecting only a part of the generated secondary ions as the secondary ion group, and hence the mass resolution in a secondary ion mass spectrum to be obtained can be enhanced. Note that, the secondary ion group selecting mechanism may have a function of selectively separating secondary ions based on a mass.

The secondary ion group selecting mechanism may be provided in the extraction electrode or in another component. In the case where the secondary ion group selecting mechanism is provided in the extraction electrode, the secondary ion group can be selected, for example, by shortening a time width of charge application. In the case where another component is used, the a secondary ion group may be selected by setting a secondary ion group selecting electrode between the extraction electrode and the mass separation portion and controlling voltage application to the secondary ion group selecting electrode. For example, in an orthogonal time-of-flight mass spectrometer, the secondary ion group selecting electrode is provided between the extraction electrode and the mass separation portion, and the mass separation portion is provided in a direction perpendicular to the traveling direction of secondary ions directed from the extraction electrode to the secondary ion group selecting electrode. In this case, the extraction electrode constantly extracts the secondary ions and repeats ON/OFF of the voltage application to the secondary ion group selecting electrode, with the result that a part of the extracted secondary ions can be selected as the secondary ion group, and simultaneously the secondary ion group can be introduced into the mass separation portion.

A mass separation system in the mass spectrometer is not particularly limited, and various systems such as a time-of-flight type, a magnetic deflection type, a quadrupole type, an ion-trap type, a Fourier transform ion cyclotron resonance type, an electric field Fourier transform type, and a multiturn type can be used alone or in combination.

In the case where the sample is irradiated with the ion group by the projection type, mass information and detection position information of the secondary ions can be recorded simultaneously by using the mass spectrometer including the detector having a two-dimensional ion detection function.

In the case where the sample is irradiated with the ion group by the scanning type, position information is recorded at a time of irradiation of the ion group. In this case, only a mass-to-charge ratio of the secondary ions needs to be measured, and hence a detector suitable for each mass spectrometric system may be used.

In the case where the sample is irradiated with the ion group by the scanning type, the mass spectrometer does not need to detect position information and only needs to measure a mass-to-charge ratio of the secondary ions. Therefore, a detector suitable for each mass spectrometry system may be used.

The result of mass spectrometry is analyzed by the analysis device and can be output from the output device as analyzed secondary ion mass spectrum and mass distribution image. The analysis device and output device may be integrated circuits or the like having a dedicated arithmetic operation function and a memory, or may be constructed as software in a general-purpose computer.

Analysis can be performed based on multiple secondary ion mass spectra obtained for each kind of irradiated primary ions. For analysis, each spectrum having each position information in an irradiation region may be used, and a spectrum obtained by accumulating a predetermined region in the irradiation region may be used. The analysis may include a division process of one secondary ion mass spectrum, calibration of a mass-to-charge ratio, and accumulation, averaging, and normalization of mass spectra obtained through irradiation of ion groups of the same kind.

An analysis method of analyzing a difference among multiple secondary ion mass spectra is not particularly limited. Various processing methods such as general processing (addition, subtraction, balancing, division, and accumulation using multiple different spectra), or analysis processing based on a gentle SIMS (G-SIMS) method can be performed alone or in combination.

An example of the difference analysis for multiple obtained secondary ion mass spectra is described. The difference analysis uses the following: as the mass of primary ions to be irradiated is larger, fragmentation of sample molecules can be suppressed more and precursor ions are more likely to be obtained. FIGS. 3A to 3C illustrate an example of analysis. FIG. 3A illustrates a secondary ion mass spectrum 35 obtained through the irradiation of primary ions having a large mass, and FIG. 3B illustrates a second ion mass spectrum 36 obtained through the irradiation of primary ions having a small mass. The mass spectra 35 and 36 correspond to the secondary ion mass spectra 33 and 34 of FIG. 2B. Both of the mass spectra 35 and 36 are obtained from sample regions or positions which can be compared to each other and have secondary ion intensities which can be compared to each other. When the mass spectrum in FIG. 3B is subtracted from the mass spectrum in FIG. 3A, a difference therebetween, that is, a mass spectrum 37 is obtained as illustrated in FIG. 3C. The mass spectrum 37 is classified into peaks to be convex in a positive direction and peaks to be convex in a negative direction. In this case, as the mass of primary ions is larger, the secondary ion intensity of precursor ions is higher. Therefore, the precursor ions become convex in a positive direction, whereas the fragment ions become convex in a negative direction. Thus, the precursor ions and the fragment ions can be distinguished from each other based on the relationship between the magnitude relation of the mass of primary ions and the magnitude relation of peaks thereof.

Note that, the precursor ions refer to ions (M⁺) obtained when sample molecules (M) are ionized through the removal of electrons and ions (M⁻) obtained when sample molecules (M) are ionized through the addition of electrons, and ions obtained when sample molecules (M) are ionized through the addition or removal of specified electrons in which fragmentation has not occurred. Typical examples of ions to be generated by the addition or removal include protonated ions ([M+H]⁺), deprotonated ions ([M−H]⁺, [M−H]⁻), sodium adduct ions ([M+Na]⁺), potassium adduct ions ([M+K]⁺), ammonium adduct ions ([M+NH₄]⁺), and chlorine adduct ions ([M+Cl]⁻). Besides those, the typical examples also include adducts of metal ions, ions derived from a primary ion species, and ions derived from a matrix around sample molecules.

Further, a mass distribution image in which precursor ions and fragment ions are clearly discriminated from each other can also be obtained based on a secondary ion mass spectrum in which precursor ions and fragment ions are clearly distinguished from each other.

As described above, the sample can be irradiated with two or more ion groups having different average masses of ions forming the ion groups in a short period of measurement time by the secondary ion mass spectrometer of the present invention. Thus, two or more different secondary ion mass spectra can be obtained in a short period of time, and hence the peak distinction between precursor ions and fragment ions and the identification of a sample molecule species can be performed with satisfactory throughput.

### Second Embodiment

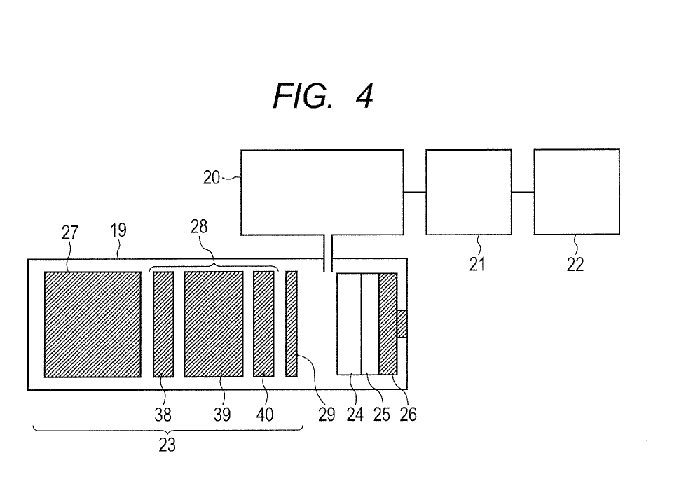

The configuration of this embodiment is described with reference to FIG. 4.

In this embodiment, the ion group selecting unit 28 includes a first chopper 38 positioned on the ion source side, a second chopper 40, and an ion separator 39 disposed between the first and second choppers 38, 40. The first and second choppers 38, 40 perform a chopping operation of selecting an ion group by changing from a closed state to an opened state for a predetermined period of time, thereby passing ions in a traveling direction only for the predetermined period of time. The second chopper 40 has a feature of performing two or more chopping operations for one chopping operation by the first chopper 38.

Ions released from the ion source include various kinds of ions and form an ion aggregate having an infinite time width or a large time width. The time width of the ion aggregate refers to a width of a time period during which ions are released from the ion source. The ion aggregate first reaches the first chopper 38 and is selected as the first ion group including ions having a small time width and various masses by the chopping operation of the first chopper 38. Next, the first ion group is further separated by the ion separator 39, and then subjected to two or more chopping operations by the second chopper 40. As described above, two or more second ion groups having a small time width, less mixed ions other than target ions, and different masses can be obtained in a short period of time.

As described above, when the first chopping operation, ion separation, and second chopping operation are performed, an ion group having a small time width and less mixed ions other than target ions can be obtained easily. When an ion group has a small time width and less mixed ions other than target ions, the enlargement of the time width of the ion group up to the time when the ion group reaches the sample surface can be reduced, and hence the mass resolution of generated secondary ions can be enhanced. Therefore, the first chopper 38, the second chopper 40, and the ion separator 39 disposed between the first and second choppers 38, 40 can be used preferably.

The other configurations are the same as those of the first embodiment.

### Third Embodiment

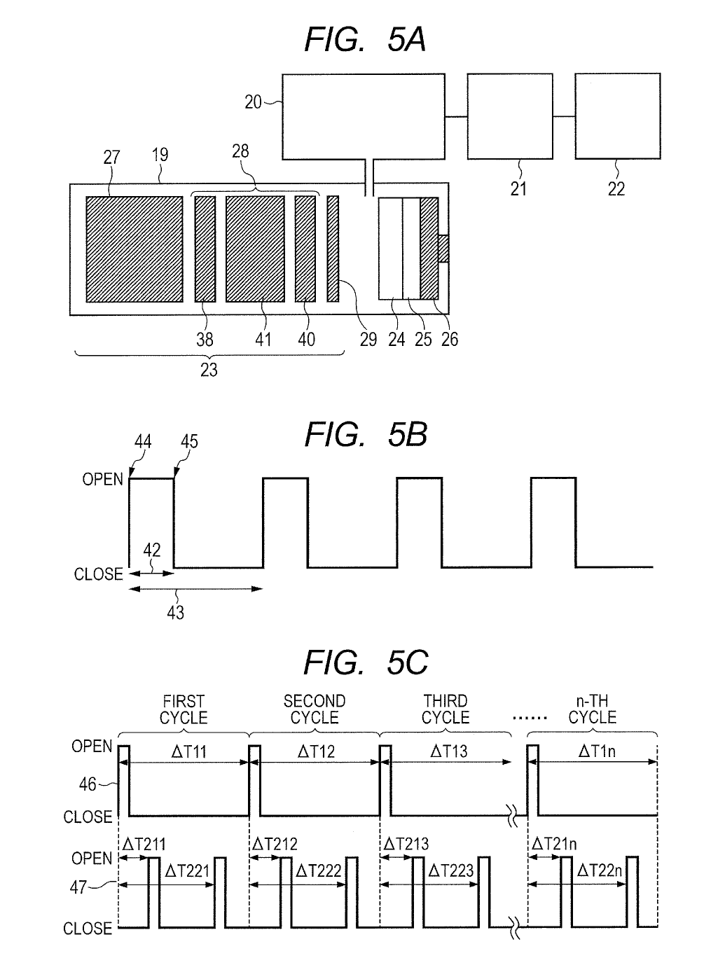

The configuration of this embodiment is described with reference to FIGS. 5A to 5C.

FIG. 5A is a schematic view illustrating an apparatus of this embodiment. In this embodiment, a time-of-flight mass separator 41 is used as the ion separator 39 disposed between the first chopper 38 and the second chopper 40.

The time-of-flight mass separator 41 has high mass resolution. In addition, a parameter to be controlled for separating ions into an ion group is only a time difference due to the use of the time-of-flight mass separator 41, and hence the convenience and accuracy of control are enhanced. As described above, an ion group having high mass resolution and high mass accuracy is obtained easily, and hence the above-mentioned apparatus can be used preferably.

The operation of FIG. 5A is described. An ion aggregate including ions having various masses and having an infinite or large time width released from the ion source is subjected to one chopping operation by the first chopper 38, with the result that one first ion group is selected. The first ion group has a small time width and includes ions having various masses. Next, the first ion group including ions having various masses flies at a speed corresponding to each mass-to-charge ratio in the time-of-flight mass separator 41. Thus, the ions of the first ion group are separated for each mass-to-charge ratio and form multiple ion aggregates each mainly including ions having a specified mass and having a large time width. Note that, the multiple ion groups each have a large time width, and hence may overlap each other in some cases. Next, two or more ion groups mainly including target ions of the multiple ion aggregates are subjected to two or more chopping operations by the second chopper 40. Consequently, two or more second ion groups having a short time width, including less mixed ions other than target ions, and having different masses can be obtained in a short period of time.

An example of a timing chart of opening and closing of the chopper according to this embodiment is described with reference to FIGS. 5B and 5C.

As illustrated in FIG. 5B, a period of time during which a chopper is opened is referred to as a chopper opening time period 42, a period of time from opening of the chopper to the next opening thereof is referred to as an opening interval 43, time at which the chopper is opened is referred to as opening time 44, and time at which the chopper is closed is referred to as closing time 45. The chopper opening time period 42 corresponds to a time width of an ion group obtained by opening and closing of the chopper. Further, the operation of performing opening and closing is also referred to as a chopping operation.

A timing chart 46 of the first chopper 38 of FIG. 5C illustrates that the first chopper 38 performs n opening and closing operations in opening intervals ΔT11 to ΔT1n. In FIG. 5C, “Open” indicates that the chopper is opened (which passes ions in a traveling direction), and “Close” indicates that the chopper is closed (which blocks the traveling of ions). FIG. 5C illustrates an example in which intervals of opening are all equal to each other. However, it is not necessary required that the intervals of opening are equal to each other, and they may be different from each other. A timing chart 47 of the second chopper illustrates that the second chopper 40 performs two chopping operations with respect to one chopping operation of the first chopper 38, that is, the second chopper 40 performs 2n operations in total. Assuming that two operations by the second chopper 40 correspond to one cycle, the difference between the opening time of the first chopper 38 and the opening time of the second chopper 40 is ΔT211 at the first time in the first cycle and ΔT221 at the second time in the first cycle; ΔT212 at the first time in the second cycle and ΔT222 at the second time in the second cycle; ΔT213 at the first time in the third cycle and ΔT223 at the second time in the third cycle; and ΔT21n at the first time in the n-th cycle and ΔT22n at the second time in the n-th cycle. Further, FIG. 5C illustrates an example in which ΔT211 to ΔT21n are all equal to each other. However, they may vary for each cycle. The variation may be made on a random basis or on a regular basis. Further, FIG. 5C illustrates an example in which ΔT221 to ΔT22n are equal to each other. However, they may vary for each cycle. The variation may be made on a random basis or on a regular basis. Further, in each of the first to n-th cycles, the second chopper 40 performs two operations with respect to one chopping operation by the first chopper 38, but the second chopper 40 is not required to constantly perform two operations with respect to one operation by the first chopper 38. As long as the second chopper 40 performs two or more operations at least in one cycle, the second chopper 40 may perform any number of operations in each cycle, and the number of operations may vary for each cycle. The variation may be made on a random basis or on a regular basis.

The difference between the opening time of the first chopper 38 and the opening time of the second chopper 40 is not particularly limited and may be set randomly or in an intended manner. For example, the second chopper 40 may be operated in accordance with the time difference in which ions having a specified mass pass through the second chopper 40 for the purpose of irradiating a sample with the ions having the specified mass.

Note that, a period of time from the time when the ions having a specified mass-to-charge ratio pass through the first chopper 38 to the time when the ions reach the second chopper 40 can be calculated as delay time (time-of-flight time). That is, a period of time “t” during which ions having a mass “m” and a charge number “z” flying with an acceleration voltage V fly through a flight-path length having a total length L at an equal speed can be obtained by Expression (1).

t=L(m/2zeV)^{1/2} (1)

where “e” represents an elementary charge.

The difference between the opening time of the first chopper 38 and the opening time of the second chopper for passing ions having a specified mass can be determined by applying, to Expression (1), the flight-path length L as the length of the time-of-flight mass separator 41 or as a distance between the first chopper 38 and the second chopper 40 (in the case where the time-of-flight mass separator is not provided separately from a device barrel and a potential is provided based on a ground potential). Note that, the mass resolution is enhanced as the flight-path length is larger. However, the flight-path length is preferably about 0.1 m to 1 m from the viewpoint of the throughput and constraint of a space.

Although the opening period of time of the first chopper 38 is not particularly limited, the opening period of time is in a range of about 0.5 nsec to 50 μsec. The opening period of time of the first chopper 38 influences the mass resolution in the later time-of-flight mass separator, and hence may be determined considering various parameters such as a time-of-flight length and an acceleration voltage and desired mass resolution of primary ions. The opening period of time of the first chopper 38 may be constant or vary for each cycle. The variation may be made on a random basis or on a regular basis.

Although the opening period of time of the second chopper 40 is not particularly limited, the opening period of time is in a range of about 0.5 nsec to 50 μsec. Note that, the opening period of time may influence the mass resolution of secondary ions emitted from the sample by the irradiation of primary ions. That is, when the time width of an ion group of primary ions is too large, the uncertainty about the time when secondary ions are generated increases, which may degrade the mass resolution in some cases. On the other hand, as the mass-to-charge ratio of primary ions becomes larger, the period of time up to a time when the primary ions pass through the second chopper 40 becomes longer, and an opening period of time is set to be longer. Considering the foregoing, the opening period of time may be determined. The opening period of time of the second chopper 40 may be constant or vary for each cycle. The variation may be made on a random basis or on a regular basis. The other configurations are the same as those of the above-mentioned embodiments.

### Fourth Embodiment

In this embodiment, in the primary ion irradiation unit, a combination of one chopping operation by the first chopper and two or more chopping operations by the second chopper coordinated with the chopping operation by the first chopper is defined as one cycle. At this time, the sample is successively irradiated with two or more second ion groups selected from at least one cycle in the order from second ion groups including ions having a smaller mass.

In the case of using a time-of-flight mass separator as the ion separator, in one cycle, the second ion groups are selected successively from those including ions having a smaller mass. Therefore, in the case where the sample is irradiated with the second ion groups successively from those including the ions having a smaller mass, it is not necessary to exchange the order of the ion groups between the ion selection and the irradiation. Thus, a time of period from the selection of ions to the irradiation thereof can be shortened most regarding each ion group.

The other configurations are the same as those of the above-mentioned embodiments.

### Fifth Embodiment

In this embodiment, as the mass spectrometer for measuring secondary ions generated from the sample, a time-of-flight mass spectrometer is used.

The time-of-flight mass spectrometer guides all the secondary ions generated from the sample to an extraction electrode and accelerates the secondary ions at an acceleration voltage V, and thereafter allows the secondary ions to fly through a free space having the flight-path length L to reach a detector. The secondary ions are separated for each mass-to-charge ratio, and hence the mass “m” of each secondary ion can be determined based on Expression (1) by measuring the arrival time “t” of the ions to the detector.

The time-of-flight mass spectrometer is capable of performing high-sensitivity analysis due to its high transmittance of ions. Moreover, the time-of-flight mass spectrometer has high mass resolution and facilitates the separation between peaks, and hence the distinction between the precursor ions and the fragment ions is rendered easy. The other configurations are the same as those of the above-mentioned embodiments.

### Sixth Embodiment

In this embodiment, in irradiation of two or more second ion groups to the sample, the irradiation of each second ion group is measured by the mass spectrometer. One measurement is performed for one irradiation, and hence the measurement time of a secondary ion spectrum can be varied depending on the mass of the second ion group to be irradiated.

For example, as the mass of ions forming the second ion group becomes larger, the measurement time of the secondary ion spectrum can be rendered longer.

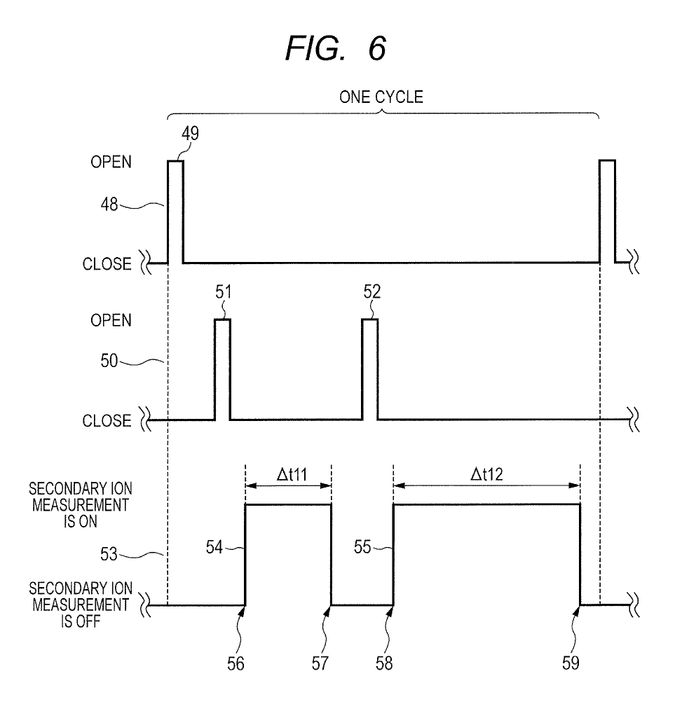

FIG. 6 illustrates a timing chart of primary ion irradiation and secondary ion measurement in this embodiment. In a timing chart 48 of the first chopper 38, one first ion group is selected by a chopping operation 49. Two second ion groups are selected from the first ion group by chopping operations 51, 52 in a timing chart 50 of the second chopper 40, and the sample is irradiated successively with the second ion groups. In this case, it is assumed that the mass of ions forming the ion group selected by the chopping operation 51 is smaller than that of the ion group selected by the chopping operation 52. The secondary ions generated by the irradiation of each ion group are measured once for each of measurement operations 54, 55 for measurement time periods Δt11, Δt12 by the time-of-flight mass spectrometer, as illustrated in a timing chart 53.

In this case, as illustrated in FIG. 6, as the mass of ions forming the ion group to be irradiated becomes smaller, the measurement time of secondary ions becomes shorter. The reason for this is as follows.

The measurement time of the time-of-flight mass spectrometer depends on the mass range to be measured. As the mass of secondary ions becomes larger, the arrival time of ions to the detector becomes longer based on Expression (1). Therefore, measurement takes time. On the other hand, as the mass of primary ions becomes smaller, secondary ions having a large mass are unlikely to be generated, and measurement may be sufficient in some cases in a range of a small mass. Thus, as the mass of ions forming the ion group to be irradiated becomes smaller, the measurement time of secondary ions can be shortened.

In this embodiment, the measurement time of secondary ions can be changed in accordance with the mass of primary ions. Therefore, even in the case where the sample is irradiated with two or more ion groups, the measurement time for one cycle can be made shortest, and the measurement time of the entire cycle can also be shortened. This is effective, in particular, in the case of using the time-of-flight mass separator for selecting the second ion groups. For example, in the case of using the separator, it takes long time for selecting ion groups formed of ions having a large mass. However, as illustrated in FIG. 6, an operation of selecting an ion group formed of ions having a small mass, irradiating the sample with the ion group, and measuring secondary ions can be completed within the time.

Note that, measurement start times 56, 58 of secondary ions are not particularly limited and may be coordinated with the opening time or the closing time of the second chopper 40. Further, measurement end times 57, 59 and measurement time periods of secondary ions are not particularly limited, and may be determined based on any of an arbitrary measurement time period, mass of ions forming the second ion groups to be irradiated, an arbitrary measurement mass range, and the next opening time or closing time of the second chopper 40 (in FIG. 6, closing time 57 of a secondary ion measurement operation 54 with respect to opening time or closing time of the chopping operation 52).

Note that, there is no limit to the difference in mass of ions forming two or more ion groups to be irradiated. Note that, in the case where the time-of-flight mass separator is used for selecting the second ion group, and the time difference for irradiation is the same as that for selection, a time difference is unlikely to be obtained between ion groups if the masses are close to each other, and hence the detection time periods of secondary ion spectra may overlap each other in some cases. Therefore, in this embodiment, in the case where the time-of-flight mass separator is used for selecting the second ion group, and the time difference for irradiation is the same as that for selection, the difference between the masses is preferably 1,000 or more, more preferably 10,000 or more.

The other configurations are the same as those of the above-mentioned embodiments.

### Seventh Embodiment

In this embodiment, the opening time or closing time in the chopping operation of the second chopper 40 is used as the measurement start time of the time-of-flight mass spectrometer.

In the present invention, the measurement start time of the time-of-flight mass spectrometer is not particularly limited. Note that, the measurement operation can be simplified and controlled easily through use of the opening time or closing time in the chopping operation of the second chopper 40.

The other configurations are the same as those of the above-mentioned embodiments.

### Eighth Embodiment

In this embodiment, the opening time and closing time in the chopping operation of the second chopper 40 are used as the measurement start time of the time-of-flight mass spectrometer.

In the present invention, the measurement start time and the measurement end time (that is, measurement time period) of the time-of-flight mass spectrometer are not particularly limited. Note that, in the case where a measurement operation by the time-of-flight mass spectrometer is performed for each irradiation of the second ion group, the measurement operation can be simplified and controlled easily through use of the closing time in the chopping operation of the second chopper 40 as the measurement start time of the time-of-flight mass spectrometer and through use of the opening time in the chopping operation of the second chopper 40 as the measurement endtime of the next time-of-flight mass spectrometer. In addition, the measurement time of secondary ions can be kept longest with respect to the irradiation of each second ion group, and hence a secondary ion spectrum having a largest mass range can be obtained.

The other configurations are the same as those of the above-mentioned embodiments.

### Ninth Embodiment

In this embodiment, the mass spectrometer performs one measurement operation in one cycle.

In this embodiment, secondary ion spectra obtained thorough the irradiation of two or more ion groups are obtained as one secondary ion spectrum. Note that, the secondary ion spectra corresponding to the kinds of ion groups to be irradiated are sufficiently separated from each other in terms of time. Therefore, two or more different secondary ion spectra corresponding to the kinds of ion groups to be irradiated can be obtained by dividing the above-mentioned one secondary ion spectrum.

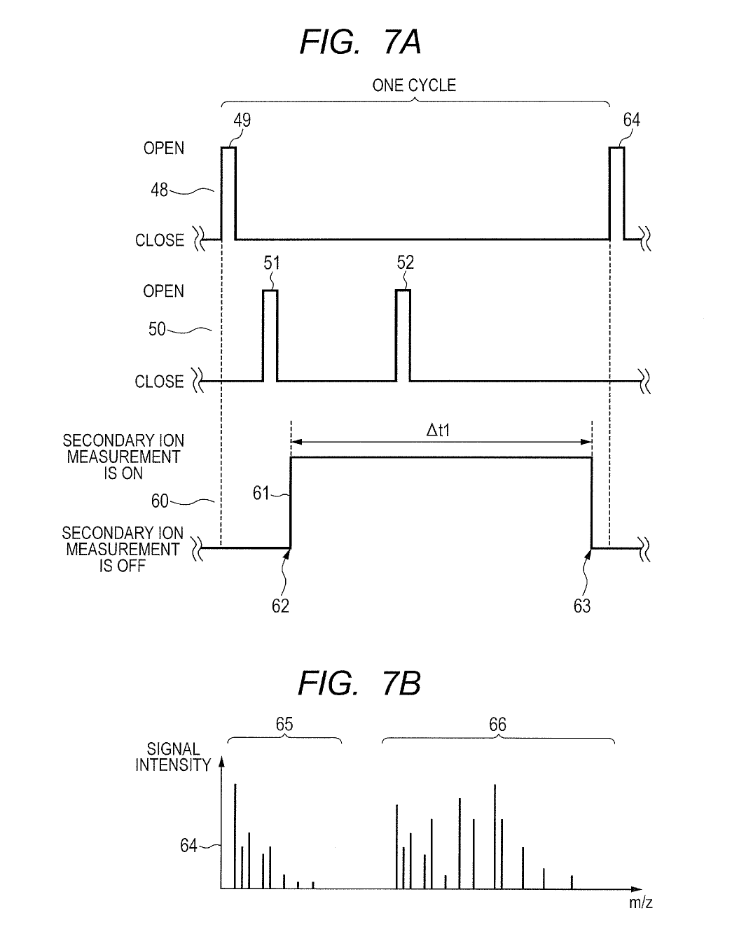

FIG. 7A is a timing chart of primary ion irradiation and secondary ion measurement in this embodiment. It is assumed that the timings of ion selection and ion irradiation are the same as those of the sixth embodiment. In the ninth embodiment, as illustrated by a timing chart 60 of secondary ion measurement, secondary ions generated when the sample is irradiated with all the ions selected in one cycle are measured for a measurement time period Δt1 by one measurement operation 61.

FIG. 7B schematically illustrates one secondary ion spectrum obtained in this embodiment. The sample is irradiated with primary ions from those having a smaller mass, and hence the difference in irradiation time of primary ions is also reflected on obtained secondary ions. That is, in a secondary ion spectrum 64 of FIG. 7B, a region 65 in which the mass of secondary ions is small represents secondary ions obtained from primary ions having a small mass, and a region 66 in which the mass of secondary ions is large represents secondary ions obtained from primary ions having a large mass. As the mass of the primary ions becomes smaller, the mass of obtained secondary ions becomes smaller. Therefore, one secondary ion spectrum obtained by two or more primary ion irradiations can be divided by analysis processing to obtain two different secondary ion spectra. Therefore, in this embodiment, it is appropriate that one secondary ion measurement is performed for two or more primary ion irradiations, and thus the control for the measurement can be simplified.

Note that, a measurement start time 62 of secondary ions is not particularly limited and may be coordinated with the opening time or closing time of the second chopper 40. Further, a measurement end time 63 and measurement time period of secondary ions are not particularly limited and may be determined based on any of an arbitrary measurement time period and the next opening time or closing time of the first chopper 38 (in FIG. 7A, closing time 63 in the secondary ion measurement operation 61 with respect to the opening time or the closing time of a chopping operation 64).

There is no limit to the difference between masses of ions forming the two or more ion groups to be irradiated. Note that, in this embodiment, in the case where the time-of-flight mass separator is used for selecting the second ion group, and a time difference for the irradiation is the same as that for selection, a time difference is unlikely to be obtained between ion groups when the masses are close to each other, and secondary ion spectra may not be separated for each ion group in some cases. Therefore, in the case where the time-of-flight mass separator is used for selecting the second ion group, and a time difference for irradiation is the same as that for selection, the difference in mass is preferably 1,000 or more, more preferably 10,000 or more.

The other configurations are the same as those of the above-mentioned embodiments.

### Tenth Embodiment

In this embodiment, an opening time or a closing time in the chopping operation performed by the second chopper 40 conducted at the earliest time in one cycle is used as a measurement start time of the time-of-flight mass spectrometer.

In the present invention, the measurement start time of the time-of-flight mass spectrometer is not particularly limited. Note that, in the case where one measurement is performed by the time-of-flight mass spectrometer in one cycle, the measurement operation can be simplified and controlled easily through use of the timing of the chopping operation by the second chopper 40 performed at the earliest time in one cycle as the measurement start time of the time-of-flight mass spectrometer.

The other configurations are the same as those of the above-mentioned embodiments.

### Eleventh Embodiment

In this embodiment, a closing time in the chopping operation performed by the second chopper 40 conducted at the earliest time in one cycle is used as a measurement start time of the time-of-flight mass spectrometer, and an opening time in the chopping operation performed by the second chopper 40 conducted at the earliest time in next one cycle is used as a measurement end time of the time-of-flight mass spectrometer.

In the present invention, the measurement end time of the time-of-flight mass spectrometer is not particularly limited in each cycle.

In the present invention, the measurement start time of the time-of-flight mass spectrometer is not particularly limited. Note that, in the case where one measurement operation is performed by the time-of-flight mass spectrometer in one cycle, the measurement operation can be simplified and controlled easily through use of the closing time in the chopping operation performed by the second chopper 40 conducted at the earliest time in one cycle as the measurement start time of the time-of-flight mass spectrometer, and through use of the opening time in the chopping operation performed by the second chopper 40 conducted at the earliest time in next one cycle as the measurement end time of the time-of-flight mass spectrometer. In addition, the measurement time of secondary ions can be kept longest with respect to the irradiation of two or more second ion groups in one cycle, and hence a secondary ion spectrum having a largest mass range can be obtained.

The other configurations are the same as those of the above-mentioned embodiments.

### Twelfth Embodiment

In this embodiment, at least one of two or more second ion groups is formed of cluster ions. The use of cluster ions can suppress the fragmentation of sample molecules. Therefore, precursor ions can be detected at high sensitivity even with respect to sample molecules having a large mass and can be distinguished from the fragment ions easily.

The range of a cluster size of cluster ions to be used is not particularly limited and may be arbitrarily determined based on the mass range of target molecules. In general, as a cluster size increases, precursor ions can be detected with satisfactory sensitivity even with respect to molecules having a large mass.

Note that, the cluster size can be calculated through use of the mass of ions forming the ion group.

The other configurations are the same as those of the above-mentioned embodiments.

### Thirteenth Embodiment

In this embodiment, an ion material for ions forming at least one ion group of two or more second ion groups contains any one of a gas, a liquid, and a mixture of a gas and a liquid at normal temperature and normal pressure. In the present invention, the kind of the ion material is not particularly limited. However, cluster ions having a larger cluster size can be generated by using a gas or a non-metal liquid as the ion material rather than by using a liquid metal. As the cluster size increases, precursor ions can be detected with high sensitivity even with respect to molecules having a large mass. Therefore, it is preferred that the ion material contain any one of a gas, a liquid, and a mixture of a gas and a liquid at normal temperature and normal pressure.

Examples of the gas at normal temperature and normal pressure include: rare gases such as argon and xenon; and oxygen. Note that, the present invention is not limited thereto.

Examples of the liquid at normal temperature and normal pressure include water, an acid, an alkali, and an organic solvent such as an alcohol. Note that, the present invention is not limited thereto.

The other configurations are the same as those of the above-mentioned embodiments.

### Fourteenth Embodiment

In this embodiment, at least one of the two or more second ion groups contains one kind of molecule of water, an acid, and an alcohol. In the present invention, a constituent atom species or molecule species of ions forming an ion group is not particularly limited. However, when a sample is irradiated with primary ions containing at least one kind of water, an acid, and an alcohol, molecules having a proton affinity such as biological molecules can be accelerated to generate proton adduct ions. As a result, the detection sensitivity of precursor ions of the molecules is enhanced. Therefore, it is preferred that at least one of the two or more second ion groups contain water molecules containing at least one kind of water, an acid, and an alcohol.

There is no particular limit to ions containing water molecules, and preferred examples thereof include [(H₂O)n]⁺ (n=1 to 100,000) and [(H₂On+mH)^{m+} (n=1 to 100,000, m=1 to 100,000).

An example using the following two ion groups is described below: an ion group in which water molecules are formed of 10±2 water cluster ions ([(H₂O)10±2]⁺); and an ion group in which water molecules are formed of 1,000±20 water cluster ions ([(H₂O)1000±20]⁺). Note that, [(H₂O)10±2]⁺ refers to ions obtained as a result of an error of ±2 in selecting an ion group although an average of the numbers of water molecules included in ions is 10. Similarly, [(H₂O)1000±20]⁺ refers to ions obtained as a result of an error of ±20 in selecting an ion group although an average of the numbers of water molecules included in ions is 1,000.

Water cluster ions can be obtained by heating water serving as an ion material with the ion material supply unit, spraying the heated water in a vacuum, and subjecting the neutral water cluster thus formed to electron impact ionization. A part of an aggregate of ionized ions having multiple cluster sizes is selected as an ion group with the first chopper 38. The ion group is subjected to mass separation with the time-of-flight mass separator. After the elapse of a specified time period ΔT1 from the chopping operation by the first chopper 38, the second chopper 40 performs a chopping operation to select an ion group formed of [(H₂O)10±2]⁺. A sample containing biological molecules is irradiated with the selected ion group formed of [(H₂O)10±2]⁺. Secondary ions from the irradiated surface are subjected to mass spectrometry for the measurement time period Δt1 by the time-of-flight mass spectrometer. Next, after the elapse of a specified time period ΔT2 from the chopping operation by the first chopper 38 (ΔT1+Δt1<ΔT2), the second chopper 40 performs a chopping operation to select an ion group formed of [(H₂O)1000±20]⁺. The sample containing biological molecules is irradiated with the selected ion group formed of [(H₂O)1000±20]⁺. Secondary ions from the irradiated surface are subjected to mass spectrometry for the measurement time period Δt1 with the time-of-flight mass spectrometer. Thus, two kinds of secondary ion mass spectra can be obtained within a short period of time. A precursor ion peak of biological molecules is obtained with satisfactory sensitivity in the two kinds of obtained spectra. Therefore, the distinction of precursor ions and the identification of biological molecule species are performed easily by comparison analysis processing. Note that, the present invention is not limited to the above-mentioned example.

The kind of the acid is not particularly limited, and preferred examples thereof include formic acid, acetic acid, and trifluoroacetic acid.

The kind of the alcohol is not particularly limited, and preferred examples thereof include methanol, ethanol, and isopropyl alcohol.

There is no particular limit to the number and ratio of water, acid, and alcohol molecules included in one ion group. Note that, as the number of the molecules is larger, a protonation ratio is enhanced in some cases.

The other configurations are the same as those of the above-mentioned embodiments.

### Fifteenth Embodiment

In this embodiment, at least one of two or more second ion groups includes rare gas molecules. In the present invention, a constituent atom species or molecule species of ions forming the two or more ion groups is not particularly limited. However, when the sample is irradiated with primary ions including rare gas molecules, the contamination of the sample surface involved in the irradiation of primary ions can be prevented because the reactivity of the rare gas molecules is low. Therefore, it is preferred that at least one of the two or more second ion groups include rare gas molecules.

Although there is no particular limit to the kind of the rare gas molecules, argon or xenon can be preferably used from the viewpoint of a mass and cost.

The other configurations are the same as those of the above-mentioned embodiments.

### Sixteenth Embodiment

In this embodiment, the mass spectrometer for measuring secondary ions includes a detector having a two-dimensional ion detection function of detecting secondary ions generated from the sample surface while keeping a positional relationship at a secondary ion generation position.

When the mass spectrometer including the detector having the two-dimensional ion detection function is used, the generation position of secondary ions on the sample surface can be recorded, and hence it is not necessary to scan primary ions. Therefore, a target region on the sample can be irradiated with primary ions simultaneously, and secondary ions at each position in the target region can be detected collectively. Consequently, compared to the case of scanning primary ions, measurement can be completed within a short period of time.

The mass spectrometer of this embodiment may include a projection adjusting electrode for adjusting a projection magnification besides an extraction electrode, a mass separation portion, and the above-mentioned detector. The projection adjusting electrode has a function of enlarging or reducing a spatial distribution of secondary ions on a two-dimensional plane perpendicular to the traveling direction of secondary ions directed to the detector.

Secondary ions generated from the sample surface due to the irradiation of the ion group are extracted by the extraction electrode supplied with a voltage of several to several 10 kV. Next, the extracted secondary ions are enlarged or reduced by any projection magnification with the projection adjusting electrode and introduced into the mass separation portion. Then, the introduced secondary ions are separated based on a mass-to-charge ratio and further enlarged or reduced as needed. In the above-mentioned process, the relative positional relationship of the secondary ions on the sample surface is kept. The separated secondary ions are successively detected with the detector, and the mass information and two-dimensional position information are recorded.

Although the mass separation system in the mass spectrometer in this embodiment is not particularly limited, for example, the detection time (corresponding to the mass of secondary ions) and detection position of secondary ions can be recorded simultaneously through use of a time-of-flight mass separation system.

There is no particular limit to the kind of the detector having the two-dimensional ion detection function, and a detector having any configuration can be used as long as the detector can detect a time and a position at which ions are detected. For example, any one of a combination of a micro-channel plate (MCP) and a two-dimensional electron position detector (for example, a delay line detector), a combination of the MCP and a fluorescent plate, a combination of the MCP and a charge-coupled device (CCD) two-dimensional detector, and a detector in which minute MCPs are arranged two-dimensionally can be used.

When secondary ions are measured through use of the mass spectrometer in this embodiment, the sample is irradiated with the ion group by the projection type, and secondary ions generated from a whole or a part of an irradiation region are measured. The irradiation position and area of the ion group can be determined arbitrarily based on the ion current amount, incident angle, distance between the sample surface and the ion irradiation unit, and the like through use of the primary ion irradiation device. The area and projection magnification of a secondary ion measurement target region can be determined arbitrarily based on the distance between the extraction electrode and the sample, voltage applied to the extraction electrode, voltage applied to the projection adjusting electrode, and the like.

When secondary ions are measured through use of the mass spectrometer in this embodiment, the secondary ions may be measured continuously or discretely for one ion group irradiation. In the case where the secondary ions are measured discretely, a mass distribution image of target molecules can be obtained at a high speed by controlling a measurement timing in accordance with the mass information of the target molecules.

The other configurations are the same as those of the above-mentioned embodiments.

### Seventeenth Embodiment

This embodiment has a feature of including an intermittent valve for supplying an ion material. In the present invention, there is no particular limit to the structure of the ion material supply unit. However, when an ion material is supplied intermittently through use of the intermittent value, a load of a vacuum discharge system can be reduced compared to the case of supplying the ion material continuously. Therefore, in the present invention, the intermittent value is preferably used.

The intermittent valve refers to a valve including an opening and having a function of repeating opening and closing intermittently. The intermittent valve may have a function of not completely closing the opening even in a closed state. Note that, it is preferred that the opening be completely closed in the closed state from the viewpoint of vacuum maintenance in a jetting space.

There are the following kinds of intermittent valves in terms of a valve disc structure: a gate valve, a glove valve, a ball valve, a butterfly valve, a needle valve, and a diaphragm valve. Further, there are the following kinds of intermittent valves in terms of a valve disc drive system: an electromagnetic valve, an electric valve, an air valve, and a hydraulic valve. As the intermittent valve of the present invention, any kind can be used. Note that, the electromagnetic valve is preferably used from the viewpoint of a response speed. Examples of the electromagnetic valve include a poppet type, a spool type, and a slide type in terms of an opening/closing mechanism of a valve seat, and any kind may be used.

There is no particular limit to a drive method of an opening and closing operation of the intermittent valve, and any suitable drive method may be selected depending on the kind of the intermittent valve. In the case where the intermittent valve is an electromagnetic valve, the opening and closing operation of the intermittent valve can be performed with satisfactory accuracy by supplying a voltage through use of a waveform generator. Further, a voltage application signal to the intermittent valve can be branched and sent to the chopper as a trigger signal at the same time or times delayed by a predetermined period of time via a delay time generation device. In this case, the jetting operation of the ion material by the intermittent valve and the chopping operation by the chopper can be coordinated with each other with satisfactory accuracy.

The other configurations are the same as those of the above-mentioned embodiments.

### Eighteenth Embodiment

This embodiment has a feature in that the number of times of irradiation of the two or more ion groups are respectively determined based on ion current values of the respective ion groups. The ion current value is measured as a value of a current flowing through a target when the target is irradiated with an ion group. The current value is a charge amount per unit time, and hence corresponds to the number of ions with which the sample is irradiated by one specified ion group. When an ion current value of a specified ion group out of multiple ion groups is small, the number of ions with which the sample is irradiated per ion group is small, and hence the number of secondary ions to be generated from the sample also becomes small. Consequently, the intensity of the obtained secondary ion mass spectrum becomes small as a whole and may not be sufficiently compared to mass spectra obtained by the irradiation of the other ion groups in some cases. In this embodiment, the number of irradiations can be set to be larger in advance, for example, with respect to an ion group having a small ion current value. That is, in this embodiment, the difference in spectrum caused by the difference in ion group is reduced, and mass spectra of secondary ions which can be compared to each other are obtained.

Although the relationship between the ion current value and the number of irradiations is not particularly limited, it is preferred that the number of irradiations be determined so that the product of an ion current value and the number of irradiations of each kind of ion groups becomes a difference within one order of magnitude for each ion group.

The ion current value may be obtained by directly measuring a current value of the second ion group or by calculating the ion current value based on a current value of a continuous ion beam before being selected to a second ion group.

In the case of directly measuring the current value of the second ion group, a micro-channel plate (MCP) is irradiated with the second ion group to obtain a mass spectrum, and a peak area value thereof is used.

On the other hand, in the case of calculating the ion current value based on the current value of the continuous ion beam, first, the sample holding mechanism or another portion in the device is irradiated with the continuous ion beam, and a current value thereof is measured. More preferably, the Faraday cup included in the sample holding mechanism is irradiated with the continuous ion beam, and a current value thereof is measured. Next, the ion current value is calculated through use of the measured current value and a duty ratio (time width of the second ion group/time interval for selecting the second ion group) for selecting the second ion group from the continuous ion beam.

The ion current value obtained as described above regarding each second ion group is fed back to setting conditions for determining the number of irradiations of the ion group irradiation device. The product of the ion current value and the number of irradiations becomes a total charge amount with which the sample is irradiated, and hence the number of irradiations can be determined based on an obtained ion current and setting of the total charge amount.

The measurement and calculation of the ion current, and the determination of the number of irradiations by the feedback of the measurement and calculation may be performed manually by a measurer or may be performed automatically by a device.

The other configurations are the same as those of the above-mentioned embodiments.

### Nineteenth Embodiment

In this embodiment, a change in ion current value or cluster size of the second ion group with which the sample is irradiated is monitored, and the monitored change is fed back to setting conditions of the device so that the change is suppressed.

In the case where the selection and irradiation of an ion group are performed for a long period of time, a current value and a cluster size of the ion group may change even when the setting conditions of the device are the same during the selection and the irradiation. In this case, measurement results vary for each cycle in which the irradiation of a second ion group and the measurement of secondary ions are repeated, and hence analysis accuracy and reproducibility are degraded. Thus, it is preferred that the change be monitored and fed back to the setting conditions of the device so that the change is suppressed.

The ion current value or the cluster size of the second ion group can be directly measured. In this case, a mass spectrum is obtained by irradiating an MCP set in the device with the second ion group. The ion current value is obtained from a peak area value of the mass spectrum, and the cluster size is obtained from the mass and half-value width in that peak. By sampling the ion current value and the cluster size regularly during the irradiation of the ion group for a long period of time through use of the above-mentioned method, changes thereof can be monitored.

Further, the ion current value of the second ion group can also be determined by calculating the ion current value based on a current value of a continuous ion beam before being selected as the second ion group. In this case, first, the sample holding mechanism or another portion in the device is irradiated with the continuous ion beam, and a current value is measured. Next, the ion current value of the ion group is calculated through use of the measured current value and a duty ratio (time width of the second ion group/start time interval of a chopping operation for selecting the second ion group) for selecting the ion group from the continuous ion beam. More preferably, the Faraday cup included in the sample holding mechanism is irradiated with the continuous ion beam, and a current value thereof can be measured. By sampling the ion current value regularly during the irradiation of the second ion group for a long period of time through use of the above-mentioned method, a change thereof can be monitored.

Further, the change in ion current value or cluster size of the second ion group can also be determined from the total amount of secondary ions generated from the sample surface to be irradiated with the second ion group. When the ion current value becomes small, the total amount of secondary ions also decreases. Further, when the cluster size becomes smaller, sputtering efficiency decreases even at the same ion current value, and hence the total amount of secondary ions also decreases. Thus, by measuring, with the mass spectrometer, the total amount of secondary ions obtained for each cycle in which the irradiation of a second ion group and the measurement of secondary ions are repeated during the irradiation of the second ion group for a long period of time, the change in ion current and cluster size can be monitored.

Any one of the ion current value and the cluster size may be monitored, or both of them may be monitored.

The result of monitoring is fed back to the setting conditions of the ion group irradiation device so that the setting conditions are adjusted. The setting conditions may be adjusted regarding an initial value of the ion current value or the cluster size in an initial stage of ion irradiation or the total amount of secondary ions generated from the sample surface to be irradiated with the ion group based on any one of an initial value at the start of irradiation of the second ion group, an average value during irradiation of the second ion group, and a value obtained by monitoring one time before this time of monitoring. Alternatively, the setting conditions may be adjusted based on a set value of the ion current value or the cluster size to be determined by the setting conditions.

There is no particular limit to the setting conditions to be adjusted by feedback. Note that, a change in ion current value or cluster size is mainly caused by a change in pressure of the ion material jetted from the intermittent value. Therefore, examples of the setting condition to be adjusted by feedback include a pressure of an ion material to be supplied to an intermittent valve, a pressure in the vicinity of the intermittent valve, and a time width and an operation time interval of the intermittent valve. Besides those, the operation time interval between the intermittent valve and the chopper, and the time width and operation time interval of the chopper may be adjusted. Further, the distance between the intermittent valve and the ionization unit may be adjusted. Further, voltages to be applied to the intermittent valve, the ionization unit, the chopper, the ion separator, and the like may be adjusted. Further, the number of irradiations of an ion group may be adjusted.

The monitoring of changes in ion current and cluster size, and the adjustment of various setting conditions by the feedback thereof may be performed manually by a measurer or may be performed automatically by a device.

The other configurations are the same as those of the above-mentioned embodiments.

### Twentieth Embodiment

This embodiment has a feature in that two or more second ion groups are formed of three or more ion groups of three or more kinds.

When the sample is irradiated with three kinds of second ion groups, three kinds of different secondary ion mass spectra are obtained. In this case, two or more kinds of mass spectra subjected to difference analysis through use of two kinds of mass spectra are obtained, which enables secondary analysis processing of further subjecting those two mass spectra to difference analysis, with the result that analysis with high accuracy can be performed. In addition, in the case where there are three or more kinds of second ion groups, secondary ion mass spectra do not necessarily need to be obtained from primary ions having masses adjacent to each other. Thus, any combination can be selected, which may omit the processing such as normalization in some cases. Therefore, three or more kinds of second ion groups can be used preferably.

The other configurations are the same as those of the above-mentioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131783, filed Jun. 24, 2013, which is hereby incorporated by reference herein in its entirety.

What is claimed is:

1. An ion group irradiation device for irradiating a sample with an ion group, comprising:
an ion group selecting unit configured to select, from ions released from an ion source, at least two ion groups formed of ions having different average masses; and
a primary ion irradiation unit configured to irradiate the sample with the at least two ion groups selected by the ion group selecting unit,
wherein the ion group selecting unit selects at least one ion group and further selects the at least two ion groups from each of the selected at least one ion group.

2. An ion group irradiation device according to claim 1,
wherein the ion group selecting unit comprises a first chopper positioned on the ion source side, a second chopper, and an ion separator disposed between the first chopper and the second chopper,
wherein the first chopper and the second chopper each perform a chopping operation of selecting an ion group by passing and blocking ions in a traveling direction through opening and closing, and
wherein the second chopper performs at least two chopping operations in coordination with one chopping operation by the first chopper.

3. An ion group irradiation device according to claim 2,
wherein the ion separator comprises a time-of-flight mass separator.

4. An ion group irradiation device according to claim 2, further comprising a primary ion irradiation unit configured to irradiate the sample with the at least two ion groups selected in at least one cycle successively from an ion group including ions having a smaller mass,
wherein the one cycle refers to a combination of one chopping operation performed by the first chopper and at least two chopping operations performed by the second chopper in coordination with the one chopping operation performed by the first chopper.

5. An ion group irradiation device according to claim 1, wherein at least one of the at least two ion groups is formed of a cluster ion.

6. An ion group irradiation device according to claim 1, wherein an ion material for the ions forming at least one ion group of the at least two ion groups includes any one of a gas, a liquid, and a mixture of a gas and a liquid at normal temperature and normal pressure.

7. An ion group irradiation device according to claim 1, wherein at least one of the at least two ion groups includes at least one kind of molecule of water, an acid, and an alcohol.

8. An ion group irradiation device according to claim 1, wherein at least one of the at least two ion groups includes a rare gas molecule.

9. A secondary ion mass spectrometer, comprising:
the ion group irradiation device according to claim 1; and
a mass spectrometer for measuring a mass of a secondary ion generated from a sample irradiated with an ion group by the ion group irradiation device.

10. A secondary ion mass spectrometer according to claim 9, wherein the mass spectrometer comprises a time-of-flight mass spectrometer.

11. A secondary ion mass spectrometer according to claim 10, wherein when the sample is irradiated with the at least two ion groups, the time-of-flight mass spectrometer performs a measurement operation with respect to irradiation of each of the at least two ion groups.

12. A secondary ion mass spectrometer according to claim 10, wherein the time-of-flight mass spectrometer starts the measurement operation simultaneously with one of an opening time and a closing time of the second chopper.

13. A secondary ion mass spectrometer according to claim 11, wherein the time-of-flight mass spectrometer uses one of an opening time and a closing time of the second chopper as a measurement start time.

14. A secondary ion mass spectrometer according to claim 10, wherein the time-of-flight mass spectrometer performs one measurement operation in one cycle.

15. A secondary ion mass spectrometer according to claim 14, wherein the time-of-flight mass spectrometer uses one of an opening time and a closing time in the chopping operation performed by the second chopper conducted at an earliest time in one cycle as a measurement start time.

16. A secondary ion mass spectrometer according to claim 14,
wherein the time-of-flight mass spectrometer uses a closing time in the chopping operation performed by the second chopper conducted at an earliest time in one cycle as a measurement start time, and
wherein the time-of-flight mass spectrometer uses an opening time in the chopping operation performed by the second chopper conducted at an earliest time in next one cycle as a measurement end time.

17. A secondary ion mass spectrometer according to claim 9, wherein the mass spectrometer comprise a detector having a two-dimensional ion detection function of detecting the secondary ion generated from a sample surface while keeping a positional relationship at a secondary ion generation position.

18. A secondary ion mass spectrometer according to claim 1, further comprising an analysis device for comparing secondary ion mass spectra for each ion group for irradiation.

19. A secondary ion mass spectrometry method, comprising:
comparing secondary ion mass spectra for each ion group for irradiation, through use of the secondary ion mass spectrometer according to claim 1; and
obtaining one of a mass spectrum and a mass distribution image based on a difference between the secondary ion mass spectra.

20. A secondary ion mass spectrometer for irradiating a sample with an ion group, comprising:
an ion group selecting unit configured to select at least two ion groups from ions released from an ion source; and
a primary ion irradiation unit configured to irradiate the sample with the at least two ion groups selected by the ion group selecting unit,
wherein the ion group selecting unit comprise a first chopper positioned on the ion source side, a second chopper, and an ion separator disposed between the first chopper and the second chopper,
wherein the first chopper and the second chopper each perform a chopping operation of selecting an ion group by passing and blocking ions in a traveling direction thorough opening and closing, and
wherein the second chopper performs at least two chopping operations in coordination with one chopping operation by the first chopper.
